(19) United States
(12) Patent Application Publication
(10) Pub. No.: US 2026/0124808 A1
(43) Pub. Date: May 7, 2026

(54) METHOD OF VOLUMETRIC ADDITIVE MAUFACTURING

(71) Applicant: NATIONAL RESEARCH COUNCIL OF CANADA, Ottawa (CA)

(72) Inventors: Antony ORTH, Ottawa (CA); Daniel WEBBER, Kanata (CA); Yujie ZHANG, Ottawa (CA); Guy GODIN, Ottawa (CA); Jonathan BOISVERT, Ottawa (CA); Chantal PAQUET, Ottawa (CA)

(21) Appl. No.: 19/116,458

(22) PCT Filed: Aug. 22, 2023
(86) PCT No.: PCT/IB2023/058353

§ 371 Date: Mar. 28, 2025

Related U.S. Application Data
(60) Provisional application No. 63/411,719, filed on Sep. 30, 2022.

(51) Int. Cl. B29C 64/393; B29C 64/124; B29C 64/241; B29C 64/255; B29C 64/30; B29C 71/04; B33Y 10/00; B33Y 40/20; B33Y 50/02

(52) U.S. Cl. CPC B29C 64/393; B29C 64/124; B29C 64/241; B29C 64/255; B29C 64/30; B29C 71/04; B33Y 10/00; B33Y 40/20; B33Y 50/02

(57) ABSTRACT

A method of volumetric additive manufacturing, comprising rotating a vial of photocurable resin; creating patterns of structured light images of an object to be manufactured so that the shape of the light dose distribution matches a desired shape of the object; correcting for diffusion within the vial; projecting the patterns of structured light images via a projector onto the rotating vial of photocurable resin thereby printing the object corrected for diffusion; and removing the printed object from the vial.

### BACKGROUND OF THE INVENTION

### 1. Field of the Invention

The present invention is directed to light-based additive manufacturing, and more particularly to methods of volumetric additive manufacturing that correct for the effects of diffusion.

Most 3D printing techniques involve adding material layer by layer. This sets some limitations on the types of applications for which 3D printing is suitable, such as printing around a preexisting object. In light-based additive manufacturing, photocurable resin is exposed to spatially structured (i.e. 3D) light that causes the resin to cure. The 3D light dose applied to the resin dictates the shape of the object that is printed, which permits printing entire complex objects through one complete revolution, circumventing the need for layering. However, the object does not cure instantaneously, but rather it takes on the order of seconds to a minute for the curing process to complete. During this time, the light dose effectively diffuses away from the intended object region and into regions where no light dose was intended. Moreover, light dose is also deposited in regions outside the desired object boundary due to unavoidable optical blurring of the projection beam (e.g. a square pixel when projected in resin becomes blurred) . As a result, small features of dimensions comparable to the dose diffusion length and projector point spread function (PSF) require more dose to cure. In addition, diffusion of the light dose into regions outside of the intended volume can result in over-exposure so that the object grows beyond the intended boundary.

This problem described above is especially prominent in volumetric additive manufacturing (VAM), including tomographic additive manufacturing (TAM), where all layers are exposed simultaneously. In this case, diffusion occurs throughout the entire print over a time scale of ˜60s, which corresponds to a diffusion length on the order of ˜0.25mm (however diffusion effects are noticeable beyond this length scale). In VAM, the major drawback of this diffusive effect is that small features do not cure under normal conditions, except when the large features are over exposed. In most cases, the small features are simply missing from the 3D print.

### 2. Description of the Related Art

At present, the best way to mitigate the diffusion effect is to use a viscous resin where diffusion effects are less prominent, but this severely restricts the available materials for printing. This also does not address the part of the effect imposed by the optical blurring of the projection image.

### SUMMARY OF THE INVENTION

It is an aspect of the present invention to provide methods to correct for the effect of diffusion in VAM. In one aspect, infilling is used so that projected light cures only the shell and interior scaffolding of the object, instead of the entire solid object. In another aspect, deconvolution is used to-correct the projections for diffusion.

The above aspects can be attained by a method of volumetric additive manufacturing, comprising: rotating a vial of photocurable resin; creating patterns of structured light images of an object to be manufactured so that the shape of the light dose distribution matches a desired shape of the object, the interior of which is infilled with a lattice structure; projecting the patterns of structured light images via a projector onto the rotating vial of photocurable resin thereby printing the object such that only the lattice structure and exterior surface of the object are cured within the photocurable resin as the vial rotates; removing the printed object from the vial; and curing the printed object to solidify any uncured photocurable resin trapped within the lattice structure.

Additional aspects can be attained by a method of volumetric additive manufacturing, comprising: rotating a vial of photocurable resin; creating patterns of structured light images of an object to be manufactured so that the shape of the light dose distribution matches a desired shape of the object; correcting for diffusion within the vial; projecting the patterns of structured light images via a projector onto the rotating vial of photocurable resin thereby printing the object corrected for diffusion; and removing the printed object from the vial.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows a typical VAM system for printing a 3D object.

FIG. 2 is a graph showing measured time to cure for a series of disks of varying thickness using the VAM system of FIG. 1.

FIGS. 3a, 3b and 3c present a comparison between a reference image of an object (FIG. 3a), an image of the resulting object with no correction (FIG. 3b), and an image of the resulting object using overexposure with no correction (FIG. 3c).

FIGS. 4a and 4b show images of light patterns for printing a series of disks of varying thickness using infilling, according to an embodiment, where FIG. 4a is a plan view and FIG. 4b is an elevation view.

FIG. 5 is a flowchart showing steps of a method of volumetric additive manufacturing using infilling, according to an embodiment.

FIG. 6 is an image of an object printed using infilling, according to an embodiment.

FIG. 7 is a graph showing measured time to cure the series of disks of varying thickness shown in FIGS. 4a and 4b.

FIG. 8 is a flowchart showing steps of a method of volumetric additive manufacturing using image deblurring, according to an embodiment.

FIGS. 9a and 9b show images of light patterns for printing a series of disks of varying thickness using image deblurring, according to an embodiment, where FIG. 9a shows an original pattern where the light dose intensity is uniform and FIG. 9b shows a corrected light pattern using deconvolution to increase light intensity near the surface of the disks.

FIG. 10 is an image of an object printed using image blurring, according to an embodiment.

FIG. 11 is a graph showing measured time to cure the series of disks of varying thickness shown in FIGS. 9a and 9b.

### DETAILED DESCRIPTION OF THE PREFERRED EMBODIMENTS

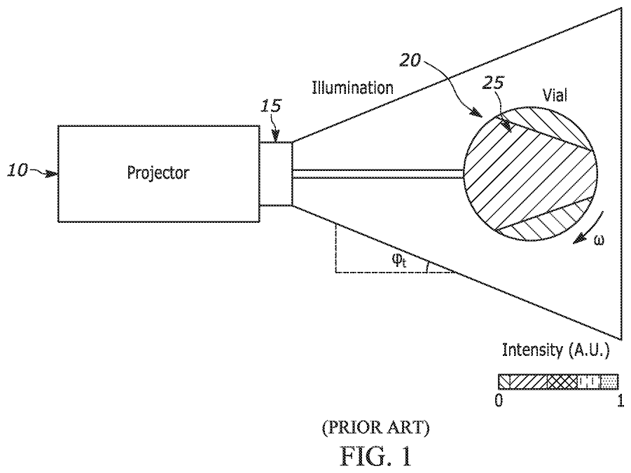

FIG. 1 shows a typical VAM system for printing a 3D object. A Digital Light Processing (DLP) projector 10 is used to project patterns of structured (i.e. 3D) light images through a lens 15 onto a vial 20 of photocurable resin 25 that is mounted to a rotation stage. In DLP projectors, an image is created by microscopically small mirrors laid out in a matrix on a semiconductor chip, known as a Digital Micromirror Device (DMD). Each mirror represents one or more pixels in the projected image, and the number of mirrors corresponds to the resolution of the projected image. In VAM, the mirrors are repositioned rapidly to reflect light through the lens 15 onto the vial 20 of photocurable resin 25. The image patterns from projector 10 are updated as the vial 20 rotates for one entire revolution (lasting ˜60 seconds) such that the shape of the light dose distribution matches the desired object shape.

VAM printing benefits from the ability to print around an existing object (overprinting) and being extremely fast (e.g. less than 1 minute/print). However, as discussed above, challenges exist in terms of print fidelity (i.e. accuracy) where large features are overexposed and small features do not appear. In particular, existing VAM systems rely on light from a pixel being projected perfectly into the resin 25 within vial 20 whereas, in fact, the light dose spreads within the print volume, for example due to oxygen diffusion, leading to local over/under exposure of large/small features.

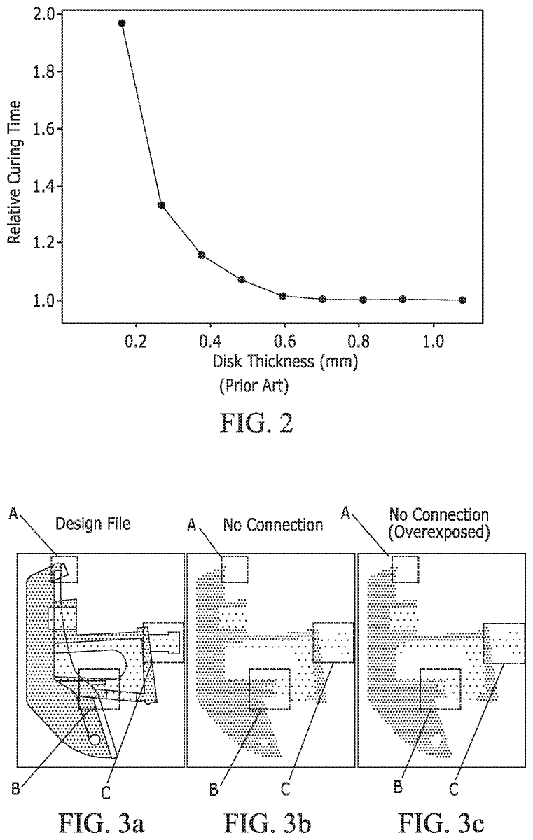

FIG. 2 is a graph showing measured time to cure for a series of disks of varying thickness using the VAM system of FIG. 1. For disks smaller than ˜0.6 mm, it will be noted that the time to cure increases significantly. To successfully cure small features, the large features must be overexposed, thereby compromising the print. This phenomenon places a fundamental limit on the range of feature sizes than can coexist in the same object printed using VAM.

FIGS. 3a, 3b and 3c present a comparison between a reference image of an object (toy boat) projected by the projector 10 (FIG. 3a), an image of the resulting object with no correction (FIG. 3b), and an image of the resulting object using overexposure with no correction (FIG. 3c), where small/thin features in FIG. 3a, fail to appear in the non-corrected print, as shown in FIGS. 3b and 3c, which is a manifestation of the diffusion phenomenon described above, while the larger feature C reproduces acceptably in the absence of overexposure (FIG. 3b). The images in FIGS. 3A, 3b and 3c can be acquired, for example, using optical scattering tomography (OST).

When no diffusion correction is applied (FIG. 3b), the steering wheel B (0.26 mm thick in design file) does not appear correctly, nor does the feature A at the back of the boat. Even when overexposed (FIG. 3c), the steering wheel B does not appear correctly, and the small feature in the back of the boat still does not appear A. At this level of overexposure, the chimney C closes up and fails to print properly.

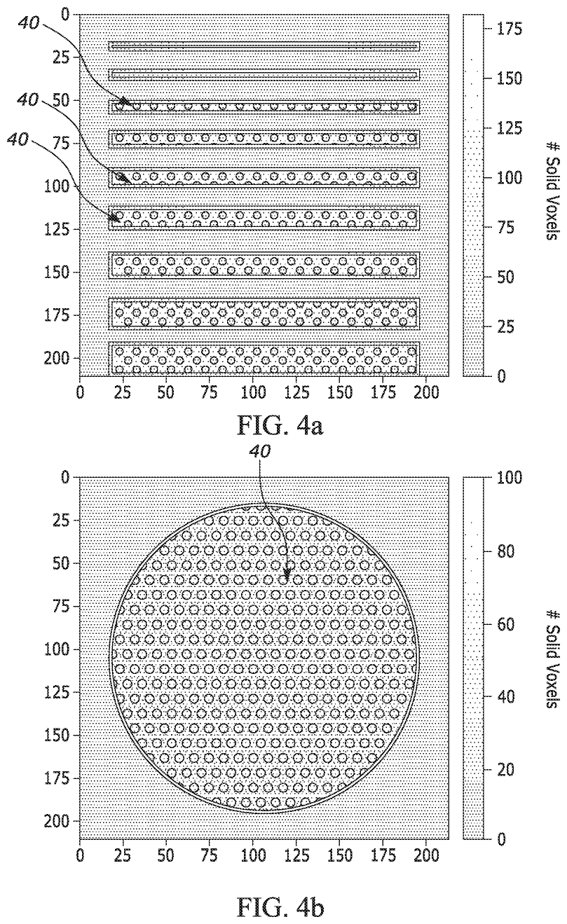

FIGS. 4a and 4b are images of a series of disks of varying thickness to be printed using infilling, according to an embodiment, where FIG. 4a is a plan view and FIG. 4b is an elevation view. In this aspect of the invention, infilling is used such that the interior of the object to be printed (i.e. the scaffolding) includes a lattice structure 40 while the exterior surface remains as a thin shell of the same thickness as the interior lattice components. As a result, only the shell and interior scaffolding of the object are cured, instead of the entire solid object. The rest of the object consists of liquid resin trapped inside the shell. Infilling can be performed, for example by a 3D slicer, for converting the digital 3D reference image into printing instructions for printing multiple horizontal 2D layers according to parameters for infill density and infill pattern. Because the shell and scaffolding infill are the same thickness everywhere, the dose reduction due to diffusion and projector blurring is uniform, such that all features of the print are cured at the same time. In FIGS. 4a and 4b a gyroid scaffolding structure is shown, although other structures such as phase centered cubic other types of lattice work arrangements may be utilized.

After being removed from the vial 20, the print, which contains trapped uncured liquid resin 25, is flood cured with ultraviolet (UV) light, such as via an LED lamp, to solidify the remaining liquid resin, producing a solid object.

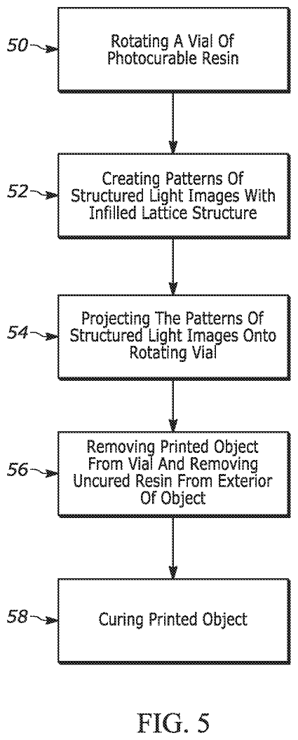

FIG. 5 is a flowchart showing steps according to the infilling method discussed above. At step 50, the vial 20 of photocurable resin 25 is rotated. At 52 patterns of structured light images of desired object are created, the interior of which is infilled with the lattice structure 40 of the same thickness as an exterior surface of the object, so that the shape of the light dose distribution matches the desired object shape. At step 54 the patterns of structured light images are projected by projector 10 through lens 15 onto the rotating vial 20 of photocurable resin 25 thereby printing the object such that only the lattice structure 40 and exterior surface of the object are cured within the photocurable resin 25 as the vial 20 rotates through at least one and preferably 5-20 rotations of the vial 20. At step 56 the printed object is removed from the vial 20, and any uncured resin on the exterior surface of the object is removed using a solvent. Then, at step 58, the printed object is cured to solidify any uncured photocurable resin trapped within the lattice structure 40 and to achieve a hard, tack-free surface.

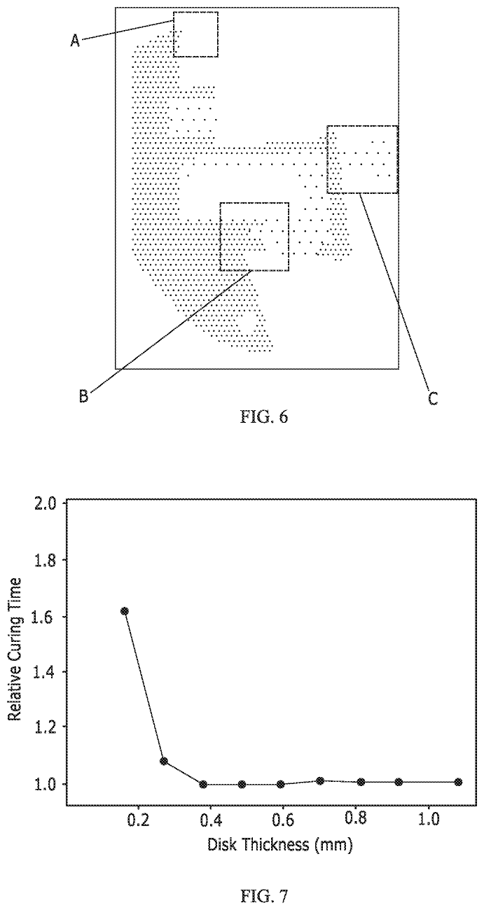

As shown in FIG. 6, the resulting object printed with infilling shell reproduces features that are larger than the shell thickness, such as the steering wheel B and chimney C, however feature A at the back of the boat still does not reproduce correctly.

FIG. 7 shows the cure time when the solid disks discussed above with reference to FIG. 2, are replaced with a shell and infill, as discussed with reference to FIGS. 4a and 4b, showing that disks with thickness >0.4 mm cure simultaneously, while 0.16 mm disks take 1.6× longer to cure than 1 mm disks.

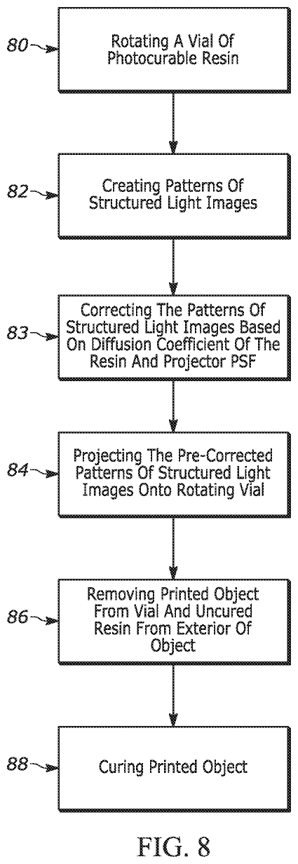

According to a second aspect, an embodiment of VAM uses image deblurring to compensate for blurring due to optical projection and oxygen diffusion. As shown in FIG. 8, steps according to this second aspect can include step 80, wherein the vial 20 of photocurable resin 25 is rotated. At step 82, patterns of structured light images of the desired object are created. At step 83, the patterns of structured light images are corrected based on the diffusion coefficient of the resin 25 and the PSF of projector 10, to account for diffusion by increasing light intensity near the surface of the object to be printed. At step 84 the corrected patterns of structured light images are projected by the projector 10 through lens 15 onto the rotating vial 20 of photocurable resin 25 thereby printing the object as the vial 20 rotates through at least one and preferably 5-20 rotations. At step 86 the finished printed object is removed from the vial 20 and any uncured resin on the exterior surface of the object is removed using a solvent, and at step 88 the object is cured to achieve a hard, tack-free surface.

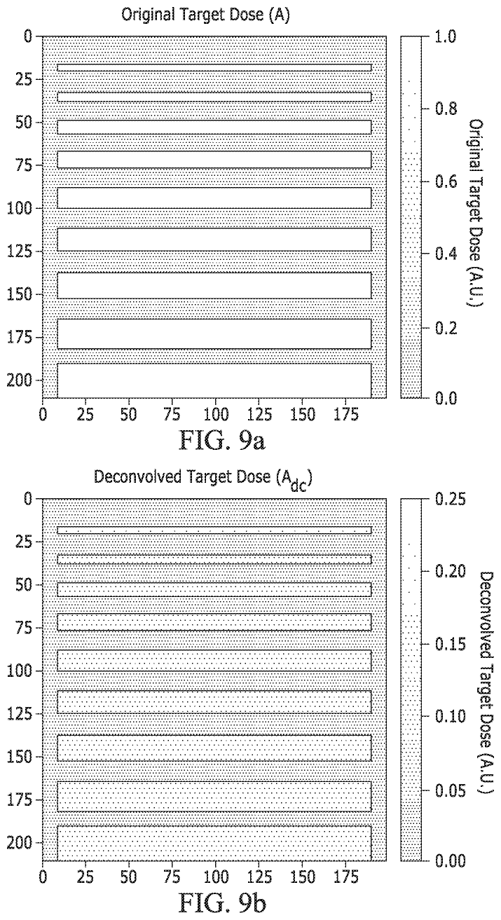

FIGS. 9a and 9b are images of the light patterns for printing a series of disks of varying thickness, according to the second aspect, where FIG. 9a shows the original pattern where the light dose intensity is uniform and FIG. 9b shows the corrected light pattern using deconvolution to increase light intensity near the surface of the disks.

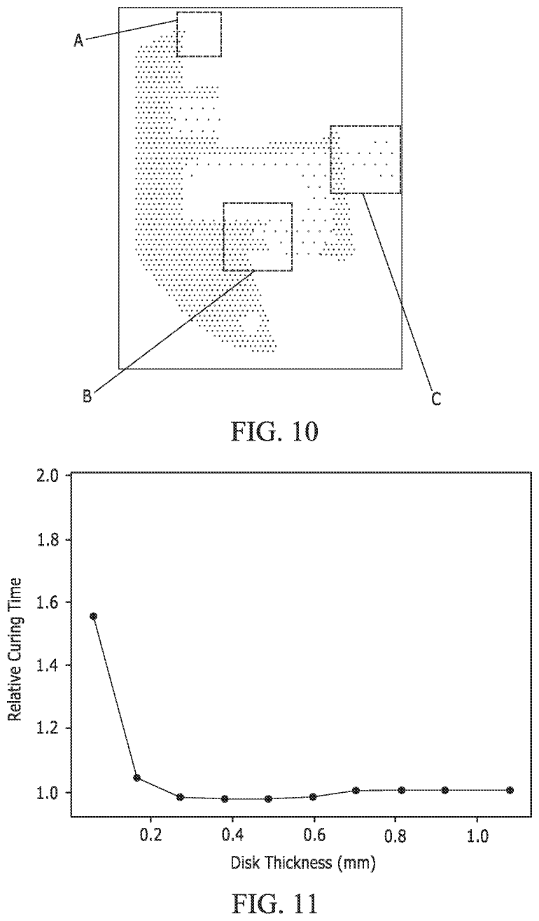

The exact amount by which the intensity is increased is determined by simulating diffusion in the build volume by solving a 3D diffusion equation for the desired object, and applying a deconvolution or optimization method to counteract the effect of diffusion. In one embodiment, an iterative deconvolution algorithm (modified Richardson-Lucy) is used to increase target light intensity near the surface of the object, where the algorithm parameters are based on physical parameters of the projector (pixel blurring) and the resin (diffusion coefficient). In this way, projector image blurring is incorporated into the deconvolution step by using a time independent blurring PSF. To do this, the diffusion coefficient and optical PSF in the resin 25 must be known. The diffusion coefficient can be measured experimentally in units of length squared per unit time (e.g. mm²/sec) using optical scattering tomography, whereas the projector PSF is imaged directly using fluorescence imaging. For example, the width of the projected blurred square pixel can be measured to determine the amount that the projector 10 blurs the intensity of the pixel. The result is that all feature sizes A, B and C cure at the same time, as shown in FIG. 10), including small features that do not appear in the non-optimized print, such as feature A, as shown in FIG. 11.

In an exemplary embodiment, the diffusion deconvolution can be performed as follows, where u₀ is the target dose intensity for the object to be printed, Dₖ is the combined diffusion kernel and projector PSF, uₙ is the nₜₕ iteration of corrected target dose intensity for the object to be printed, and N is the number of iterations:
(1) set uₙ=u₀ and 2) for n=1 to n;
(2) uₙ=uₙ*convolve(u₀/convolve(uₙ, Dₖ), Dₖ) #Richardson-Lucy deconvolution iteration;
(3) uₙ=uₙ*u₀/convolve(uₙ, Dₖ) #Modified Richardson-Lucy deconvolution iteration that rebalances corrected object intensity;
(4) Return uₙ

The combined diffusion kernel and projector PSF Dₖ is precalculated based on the known diffusion coefficient and projector PSF of the projector 10.

Lines (1)-(4) implement a deconvolution algorithm (Richardson-Lucy) to deblur the projector image based on Dₖ (the combined diffusion kernel) to sharpen the image, where line (2) includes a solution to the diffusion equation (convolve(uₙ, Dₖ)), and line (3) removes one convolution from line (2) to normalize the image and rebalances the light dose intensities by a higher dose of light to small features so that after blurring according to line (2) the small and large features are subjected to equal amounts of light intensity.

Following the diffusion deconvolution algorithm set forth above, image projections are calculated using the corrected un as the target object instead of u₀ and projected onto the rotating vial 20.

A person of ordinary skill in the art will understand that other versions of the above pseudo code may also implemented, and that other types of image deconvolution algorithms can be used to accomplish the desired image deblurring, such as the Weiner deconvolution.

In an embodiment, the print speed can be intentionally lowered by reducing the light intensity projected by the projector 10 so as to increase the magnitude of diffusion, and adding additional rotations of the vial 20, thereby allowing more time for the light dose to diffuse in order to create smooth surfaces. The increased diffusion eliminates staircase artifacts that can appear in some cases between adjacent rows of projector pixels. It should be noted that the diffusion length needs to be much greater that the pixel spacing in the vial 20 for this embodiment to work.

Both the infilling and image blurring embodiments discussed above enable printing of small and large features in complex geometries, and the relative print times are more uniform to smaller sizes with deconvolution and infill than for uncorrected, as shown in FIGS. 3a, 3b, 3c and 6. Also, small and large features cure at the same time, resulting in a print that does not have to be overexposed in large feature regions in order to cure small features. Furthermore, both the infilling and image blurring embodiments permit the use of enables low viscosity resins in the range of ˜100 cp-50 k cp as compared to conventional viscosities of ˜10 k cp) and enables easier post processing because both embodiments correct for oxygen diffusion.

The resulting improved printing fidelity for complex structures leads to applications such as printing of mechanical metamaterials useful for microgravity and space-based manufacturing, micro optics, fabrication, microfluidics fabrication and biomedical device fabrication.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### REFERENCES

Orth, Antony, et al. “On-the-fly 3D metrology of volumetric additive manufacturing.” Additive Manufacturing (2022): 102869

Orth, Antony, et al. “Correcting ray distortion in tomographic additive manufacturing.” Optics Express 29.7 (2021): 11037-11054.

Shusteff, Maxim, et al. “One-step volumetric additive manufacturing of complex polymer structures.” Science advances 3.12 (2017): eaao5496.

Kelly, Brett E., et al. “Volumetric additive manufacturing via tomographic reconstruction.” Science 363.6431 (2019): 1075-1079.

Rackson, Charles M., et al. “Object-space optimization of tomographic reconstructions for additive manufacturing.” Additive Manufacturing 48 (2021): 102367.

Rackson, Charles M., et al. “Latent image volumetric additive manufacturing.” Optics Letters 47.5 (2022): 1279-1282.

Loterie, Damien, Paul Delrot, and Christophe Moser. “High-resolution tomographic volumetric additive manufacturing.” Nature communications 11.1 (2020): 1-6.

Kelly, Brett, et al. “System and method for computed axial lithography (CAL) for 3D additive manufacturing.” U.S. Pat. No. 10,647,061. 12 May 2020.

Madrid-Wolff, Jorge, et al. “Controlling Light in Scattering Materials for Volumetric Additive Manufacturing.” Advanced Science (2022): 2105144.

Bernal, Paulina Nuñez, et al. “Volumetric bioprinting of complex living-tissue constructs within seconds.” Advanced materials 31.42 (2019): 1904209.

Bernal, Paulina Nuñez, et al. “Volumetric Bioprinting of Organoids and Optically Tuned Hydrogels to Build Liver-Like Metabolic Biofactories.” Advanced Materials 34.15 (2022): 2110054.

What is claimed is:

1. A method of volumetric additive manufacturing, comprising:
rotating a vial of photocurable resin;
creating patterns of structured light images of an object to be manufactured so that the shape of the light dose distribution matches a desired shape of the object, the interior of which is infilled with a lattice structure;
projecting the patterns of structured light images via a projector onto the rotating vial of photocurable resin thereby printing the object such that only the lattice structure and exterior surface of the object are cured within the photocurable resin as the vial rotates;
removing the printed object from the vial; and
curing the printed object to solidify any uncured photocurable resin trapped within the lattice structure.

2. The method of claim 1, wherein the interior is infilled by converting a 3D reference image into printing instructions for printing multiple horizontal 2D layers of the object according to parameters for infill density and infill pattern 3. The method of claim 1, wherein the uncured photocurable resin is flood cured using ultraviolet (UV).

4. The method of claim 1, wherein the printed object is removed after at least one complete revolution of the vial.

5. The method of claim 1, wherein the thickness of the lattice structure and exterior surface of the object is ˜0.16 mm.

6. The method of claim 1, wherein the photocurable resin is a low viscosity resin.

7. The method of claim 6, wherein the low viscosity resin has a viscosity of ˜100 cp-50 k cp.

8. A method of volumetric additive manufacturing, comprising:
rotating a vial of photocurable resin;
creating patterns of structured light images of an object to be manufactured at a target dose intensity so that the shape of the light dose distribution matches a desired shape of the object;
correcting the patterns of structured light images to a corrected target dose intensity, thereby increasing light intensity near the surface of the object to be manufactured;
projecting the corrected patterns of structured light images via a projector onto the rotating vial of photocurable resin thereby printing the object as the vial rotates, such that all features of the object cure at the same time; and
removing the printed object from the vial.

9. The method of claim 8, wherein correcting the patterns of structured light images further comprises performing an iterative deconvolution to account for diffusion of light within the vial by increasing the target dose intensity to the corrected target dose intensity near the surface of the object to be manufactured, wherein the iterative deconvolution uses a diffusion coefficient of the photocurable resin to account for light within the photocurable resin and a point-spread-function to account for pixel blurring by the projector.

10. The method of claim 9, wherein the point-spread-function is a time independent blurring point spread function.

11. The method of claim 8, wherein the iterative deconvolution is a modified Richardson-Lucy deconvolution.

12. The method of claim 11, wherein the iterative deconvolution is performed as follows:
where u₀ is the target dose intensity, Dₖ is a coefficient combining the diffusion coefficient and the point-spread-function, uₙ is an nₜₕ iteration of the corrected target dose intensity, and N is number of iterations:
set uₙ=u₀ and
for n=1 to N;
uₙ=uₙ*convolve(u₀/convolve(uₙ, Dₖ), Dₖ) #Richardson-Lucy deconvolution iteration;
uₙ=uₙ*u₀/convolve(Uₙ, Dₖ) #Modified Richardson-Lucy deconvolution iteration that rebalances corrected object intensity;
return uₙ.

13. The method of claim 9, wherein the diffusion coefficient is measured using optical scattering tomography.

14. The method of claim 9, wherein the point-spread-function is imaged using fluorescence imaging.

15. The method of claim 8, wherein the printed object is removed after at least one complete revolution of the vial.

16. The method of claim 8, wherein the photocurable resin is a low viscosity resin.

17. The method of claim 16, wherein the low viscosity resin has a viscosity of ˜100 cp-50 k cp.

18. A method of volumetric additive manufacturing, comprising:
rotating a vial of photocurable resin;
creating patterns of structured light images of an object to be manufactured so that the shape of the light dose distribution matches a desired shape of the object;
correcting for diffusion within the vial;
projecting the patterns of structured light images via a projector onto the rotating vial of photocurable resin thereby printing the object corrected for diffusion; and
removing the printed object from the vial.

19. The method of claim 18, wherein the photocurable resin is a low viscosity resin.

20. The method of claim 19, wherein the low viscosity resin has a viscosity of ˜100 cp-50 k cp.

21. The method of claim 1, wherein the lattice structure has the same thickness as an exterior surface of the object.

22. The method of claim 18, further comprising slowing the speed of the volumetric additive manufacturing by reducing the intensity of the projected patterns of structured light images so as to increase diffusion, and increasing rotations of the vial, thereby allowing more time for the light dose to diffuse in order to create smooth surfaces.
